(19) United States
(12) Patent Application Publication
(10) Pub. No.: US 2018/0012186 A1
(43) Pub. Date: Jan. 11, 2018

(54) REAL TIME DISCOVERY OF RISK OPTIMAL JOB REQUIREMENTS

(71) Applicants: Thomas Yates Baker, IV, Raleigh, NC (US); Michael R. Eby, Honeoye Falls, NY (US); Raphael Ezry, New York, NY (US); Munish Goyal, Yorktown Heights, NY (US)

(72) Inventors: Thomas Yates Baker, IV, Raleigh, NC (US); Michael R. Eby, Honeoye Falls, NY (US); Raphael Ezry, New York, NY (US); Munish Goyal, Yorktown Heights, NY (US)

(73) Assignee: International Business Machines Corporation, Armonk, NY (US)

(21) Appl. No.: 15/206,362

(22) Filed: Jul. 11, 2016

(51) Int. Cl. G06Q 10/10; G06Q 10/06

(52) U.S. Cl. CPC G06Q 10/1053; G06Q 10/063112

(57) ABSTRACT

An amount of time needed to fill a job requirement is forecasted. By executing a forecasting algorithm, a numerosity of resumes matching the job requirement during the amount of time is forecasted. Using the numerosity and the amount of time, a risk value is computed corresponding to the job requirement, the risk value being indicative of a probability that the job requirement will go unfulfilled in the amount of time. From a base tuple corresponding to the job requirement, a second tuple is constructed, the second tuple having a distance from the base tuple. In real-time a second risk value is computed corresponding to the second tuple. When the second risk value is less than the risk value, data of the second tuple is presented as a risk minimization option for the job requirement.

### TECHNICAL FIELD

The present invention relates generally to a method, system, and computer program product for constructing job requirements of an employment opportunity for hiring a suitable candidate for the opportunity. More particularly, the present invention relates to a method, system, and computer program product for real-time discovery of risk optimal job requirements.

### BACKGROUND

Hereinafter, “real-time” refers to a meeting duration during which two people, e.g., a hiring manager and a recruiter, converse to construct a job requirement for an available job opening or employment opportunity. Typically, this duration spans a few minutes, e.g., 15-120 minutes, for each available opportunity. Events occurring in this duration are regarded as occurring in real-time for the purposes of the illustrative embodiments.

Typically, job seekers, i.e., candidates, submit their resumes to a resume repository. A resume of a candidate describes the candidate's skills and a level, experience, or expertise in each of those skills. A resume may also include a desired geographical location where the candidate is seeking the opportunity and additional information.

Typically, a job requirement describes a set of skills desired or needed for the available opportunity. The job requirement also describes a level, experience, or expertise that is desired from the candidates in each of those skills. A job requirement often also describes a geographical location where the opportunity is available, along with a wage or wage-range the employer expects to pay for the opportunity, and a timeframe—referred to as “time to fill”—within which the employer expects to fill the opportunity, i.e., complete the hiring process for the opportunity.

### SUMMARY

The illustrative embodiments provide a method, system, and computer program product. An embodiment includes a method that forecasts an amount of time needed to fill a job requirement. The embodiment forecasts, by executing a forecasting algorithm using a processor and a memory, a numerosity of resumes matching the job requirement during the amount of time. The embodiment computes, using the numerosity and the amount of time, a risk value corresponding to the job requirement, the risk value being indicative of a probability that the job requirement will go unfulfilled in the amount of time. The embodiment constructs, from a base tuple corresponding to the job requirement, a second tuple, the second tuple having a distance from the base tuple. The embodiment computes, in real-time, using the processor and the memory, a second risk value corresponding to the second tuple. The embodiment presents, responsive to the second risk value being less than the risk value, data of the second tuple as a risk minimization option for the job requirement.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts;

FIG. 4 depicts;

FIG. 5 depicts;

FIG. 6 depicts; and

FIG. 7 depicts. . . . TO BE COMPLETED WHEN THE CLAIMS ARE FINALIZED IN THE SECOND DRAFT.

### DETAILED DESCRIPTION

The illustrative embodiments recognize that job requirements as posted by a hiring manager are often far from precise. Quite often, the job requirements for a job opportunity do not have a precise definition for the opportunity.

For example, in many cases, the requirements for an opportunity are exceedingly optimistic, and require a candidate to possess an over-inclusive list of skills and expertise. While it would obviously be best to find a candidate who possesses every skill one could possibly ask for, and is an expert at all of those skills, such candidates are usually a figment of imagination. When such a candidate can be found, it is highly unlikely that the candidate will be available at the location of the opportunity, for the wages that are offered for the opportunity, or both.

The illustrative embodiments recognize that hiring managers often know, or realize the real or realistic requirements of an opportunity, but start the search with an over-inclusive job description to avoid missing out on a suitable candidate. The illustrative embodiments recognize that such over-inclusive job descriptions lead to mismatch between the candidates and the real requirements. The mismatch results not only in a wastage of effort on the part of all the stake holders involved, but also in missed time to fill deadlines, suitable candidates becoming disinterested, quick hiring decision with a compromise candidate near the time to fill deadline, and other risks.

The illustrative embodiments used to describe the invention generally address and solve the above-described problems and other problems related to identifying the hiring risks in a given job requirement and optimizing that requirement to minimize the risks.

An embodiment can be implemented as a software application. The application implementing an embodiment can be configured as a modification of an existing recruitment data mining system, as a separate application that operates in conjunction with an existing recruitment data mining system, a standalone application, or some combination thereof.

A large number of resumes are available at any given time in one or more resume repositories. Just about every resume is different from every other resume in a repository. A recruitment data mining system—also referred to herein as simply a “mining system”—mines the resumes to construct resume data. Resume data is a normalized view of a resume, where the normalized view constructs a skills tuple and the relative scoring of the skills in the skills tuple according to a standardized index of skills. For example, a list of standardized skills for information technology-related jobs may include various programming languages, operating systems, toolkits, middleware, integration systems, methodologies, and the like.

Once a resume has been mined to extract the standardized skills, the mining system mines the description of each skill in the resume to determine a normalized level of expertise possessed by the candidate. A normalized level of expertise can be a value on a scale. For example, 1 year of experience may be normalized to expertise level 2 on a scale of 0 to 10, “extensive” experience may be normalized based on years of employment where the expertise was acquired or used and may be normalized to 7 on the same scale.

Based on the levels of the various skills in a resume, a mining system can score the skills relative to one another. For example, a first programming language skill with skill level 7 may be scored higher than a second programming language skill with skill level 5, and so on.

Thus, given the text of a resume, the mining system produces a tuple that takes the form of {Resume id: (S₀, E₀), (S₁, E₁), (S₂, E₂), (S₃, E₃), . . . , (S₁₀, E₁₀), LOC} where each S is a skill and each corresponding E is a skill level in the skill. Resume id is any suitable manner of identifying the resume or the candidate that corresponds to the tuple, and LOC is a location of the candidate or desired by the candidate if indicated in the resume.

A large number of job requirements from a variety of employers, recruiters, and hiring managers, are available at any given time in one or more job postings repositories. Just about every job requirement is different from every other job requirement in some respect in a given repository. A mining system mines the job requirements to construct job requirement data. Job requirement data is a normalized view of a job requirement, where the normalized view constructs a tuple of the standardized skills and a normalized level of expertise desired in that skill.

Thus, given the text of a job requirement, the mining system produces a tuple that takes the form of {Req id: (S₀, E₀), (S₁, E₁), (S₂, E₂), (S₃, E₃), . . . , (S₁₀, E₁₀), LOC} where each S is a skill and each corresponding E is a desired skill level in the skill. Req id is any suitable manner of identifying the job requirement that corresponds to the tuple, and LOC is a location of the opportunity.

Wage data is available from several data sources. Wage data includes present and historical wages that have been reported for various job descriptions or position titles by various employers, recruiters, hiring managers, candidates, hired job seekers, job market analysts, etc. Wage data can be broken down by skills and expertise such that wages corresponding to a position that requires certain standardized skills and normalized skill levels can be determined.

An embodiment collects or receives the resume data at a given time. Using the resume data, the embodiment computes a frequency of a given skills tuple, i.e., a frequency or numerosity at which that tuple is available in the resume repository. The embodiment associates with the skills tuple that frequency, resulting in a tuple that takes the form {(S₀, E₀), (S₁, E₁), (S₂, E₂), (S₃, E₃), . . . , (S₁₀, E₁₀), LOC, Frequency}. This resulting tuple forms a base tuple.

The embodiment computes a second frequency of a second tuple that is at a distance from the base tuple. In one embodiment, the distance is a number of skills that are different between the base tuple and the second tuple. As an example, consider that the skills tuples include eleven skills S₀-S₁₀ and their corresponding eleven expertise levels. A distance of 1 means that the base tuple and the second tuple each include nine common skills, e.g., S₀-S₉ and one different skill each, e.g., S₁₀ in the base tuple and S′₁₀ in the second tuple.

The different skills can be different in different second tuples. When more than one skill is different, the distance is that number of different skills.

In another embodiment, the distance is a change or a difference between the amounts of expertise of a skill common to the base tuple and the second tuple. As an example, consider that the skills tuples include eleven skills S₀-S₁₀ and their corresponding eleven expertise levels E₀-E₁₀. A distance of 1 means that the base tuple and the second tuple each include all common skills but one skill with a different level of expertise, e.g., E₀-E₉ and one different skill level each, e.g., E₁₀ in the base tuple and E′₁₀ in the second tuple.

The different skill levels can be selected differently in different second tuples. When more than one skill level is different, the distance is that number of different skill levels.

These examples of skill tuples, standardized skills, skill levels, normalized levels, resume data, requirements data, distances are not intended to be limiting. From this disclosure, those of ordinary skill in the art will be able to conceive many other skill tuples, standardized skills, skill levels, normalized levels, resume data, requirements data, distances and the same are contemplated within the scope of the illustrative embodiments.

In this manner, an embodiment can compute the frequencies of different skill tuples at different distances from a given base tuple. As an example, the base tuple may be the tuple constructed from a job requirement of a current opportunity that is sought to be filled using an embodiment.

A set of skills tuple that corresponds to a set of resumes available in a repository at a given time forms the available supply (of candidates or resources) at the given time. A set of skills tuple that corresponds to a set of job requirements available in a repository at the given time forms the available demand (of candidates or resources) at the given time. An embodiment matches the supply tuples with the demand tuples. Some supply tuples may be demanded by higher than a threshold number of demand tuples, and some supply tuples may be demanded by up to the threshold number of demand tuples.

Generally, different supply tuples match different demand tuples to different degrees. The supply tuples that have higher than the threshold degree of match with demand tuples are deemed more important—or higher in demand—than the supply tuples that have lower than the threshold degree of match with demand tuples.

From time to time, an embodiment computes and stores the supply tuples, the demand tuples, and the match values, thus forming a historical repository of demand and supply matching.

Using the historical repository of demand and supply matching, the embodiment predicts a future gap or glut in the supply. In other words, the embodiment predicts whether a particular supply tuple will be available in numbers exceeding a threshold (glut or oversupply) or in numbers below the threshold (gap or undersupply). As a non-limiting example, the supply tuples, the demand tuples, and the match values in the historical repository can be regarded as time-series, which can be used in a suitable forecasting algorithm to make the gap or glut predictions.

Completed hiring data is also available from a variety of data sources. The completed hiring data includes data about a skill set that was demanded (by a job requirement), a skill set that was supplied (by a candidate), where (location) the supplied skill set was used to fill the demanded skill set, how long after the demand was opened (time to fill), and optionally additional information.

Given a current job requirement, an embodiment constructs a base tuple of the current job requirement. Using the gap and glut predictions and the completed hiring data, the embodiment predicts a time to fill the current job requirement. Again, as a non-limiting example, the data resulting from gap and glut predictions and the completed hiring data can be regarded as time-series, which can be used in a suitable forecasting algorithm to make the time to fill predictions.

In this manner, the embodiment is able to compute, in real time, a degree of match likely for the given job requirement in the forecasted supply, and how long the job requirement can be expected to remain open before the opportunity is filled. In other words, the embodiment computes whether the skill set required by the demand tuple has any matching supply tuples in the present market, a degree of match that can be expected for the demand tuple given a gap or a glut and the extent thereof forecasted for such supply tuples, and given historical time to fill similar demands, an amount of time to fill that can be expected for the current job requirement.

The embodiment further applies a suitable function to a degree of match predicted for the given demand tuple and the expected time to fill the job requirement corresponding to the demand tuple. The function outputs a risk value corresponding to the job requirement in real time.

In one embodiment, the function further accepts as an additional input a wage that is offered for the job requirement. the risk value computed for the job requirement is adjusted according to the wage data of completed hiring data, the wage data for various skills tuples, or some combination thereof. For example, the risk value increases when the offered wage is lower than the wage of a similar completed hiring or the wage of a matching supply tuple. Similarly, the risk value decreases when the offered wage is higher than the wage of a similar completed hiring or the wage of a matching supply tuple.

Note that while manual screening of resumes has long been known to fill open job opportunities, a manual process that can assess the present supply and demand conditions, make predictions of the supply and demand conditions during the desired time to fill period, and compute the risk values based on these factors and/or the wage and/or the location of the opportunity, all in real-time while ascertaining the optimal job requirement for the opportunity, is not manually possible. To perform these tasks manually, even if that were possible, would take an amount of time that would far exceed the time to fill for many open opportunities. Furthermore, the data on which manual calculations would be performed would become stale long before the computation would be produce a result that is usable in a manner described herein.

An embodiment further computes risk minimization options for a given job requirement. For example, as described herein, a base tuple can be formed from an initial job requirement and the risk value computed relative to the base tuple. The embodiment computes a second tuple at a certain distance from the base tuple as described herein. The embodiment regards the second tuple as a replacement option for the base tuple and computes a second risk value.

Different second tuples are selected in this manner and different second risk values result therefrom. Given unlimited time, the embodiment can exhaustively compute all second tuples and their corresponding second risk values. However, given the real-time needs during a meeting to ascertain the optimal job requirement, such an exhaustive computation may not be possible or desirable. Therefore, different embodiments employ different strategies for selecting the second tuples and computing their corresponding second risk values.

For example, suppose that a time limit, e.g., 1 minute, is set on the computations and the risk minimization options have to be produced at the expiry of the time limit. One example embodiment computes as many second tuples and their second risk values as possible within the time limit.

As another example, another embodiment selects a computation algorithm depending on the time limit. For example, the embodiment may use a fast but imprecise forecasting algorithm for short time limits, and slower but relatively more precise forecasting algorithm for relatively longer time limits.

As another example, another embodiment selects—randomly or otherwise—tuples as a distance where the distance is a function of the time limit. For example, the embodiment may select second tuples at short distances for short time limits, and relatively farther second tuples for relatively longer time limits.

As another example, another embodiment selects a number of data processing systems for the computations depending on the time limit. For example, the embodiment may use a larger number of data processing systems for short time limits, and a relatively smaller number of data processing systems for relatively longer time limits.

Upon the expiry of the time limit, the embodiments cease the computations of further second tuples and second risk values. A set of second tuples with a corresponding set of second risk values are thus computed within the time limit. An embodiment sorts the set of second tuples according to their second risk values. The embodiment selects a subset of the second tuples whose second risk values are less than (i.e., reduced or minimized from) the risk value of the base tuple.

The subset of second tuples are the risk minimization options for the base tuple. In other words, the embodiment offers a second tuple in the subset as an alternative to the base tuple such that the risk value is reduced from the risk value of the base tuple to the second risk value of the second tuple. Such a risk minimization option allows a hiring manager to see, in real-time, how the job requirement could be changed such that the desired skill set could still remain acceptable for the opportunity while reducing the risk of not finding a suitable candidate within the hiring constraints.

An embodiment presents a variety of the information described herein on a requisition tool. For example, according to one embodiment, the tool is configured to interactively display the presently existing supply and demand conditions, the forecasted supply and demand conditions, the base tuple of the currently specified job requirement, the importance attached to a skill in the base tuple, a risk value of the base tuple, a forecasted time to fill according to the base tuple, expected wage to fill the job requirement according to the base tuple, one or more risk minimization options, or some combination of these and other similarly purposed information.

In one embodiment, the tool further allows a user, such as a hiring manager, to provide change inputs. The change inputs can adjust the importance associated with a skill in the base tuple, including adding new skills or removing a previously specified skill, or otherwise change a base tuple, thereby creating a different job requirement and a corresponding different base tuple.

The embodiment recomputes the forecasts, risks, and options in real-time according to the different base tuple. Through the recomputations and change inputs, a hiring manager and a recruiter can arrive at an optimal job requirement in real-time during the meeting. The optimal job requirement identifies the skills set that must be had for the current opportunity, forecasts the time to fill that is acceptable to the hiring manager, at a wage that is acceptable to the hiring manager, in the location that is acceptable to the hiring manager, and at a risk value that is acceptable to the hiring manager.

A method of an embodiment described herein, when implemented to execute on a device or data processing system, comprises substantial advancement of the functionality of that device or data processing system in assessing hiring risks associated with a job requirement and optimizing the job requirement to acceptably minimize the risks. For example, presently available methods for data mining the resumes and job descriptions, whether manually or automatically, cannot produce the forecasts related to being able to fill an opportunity and the risks associated therewith. An embodiment forecasts the supply and demand conditions that can be expected during the hiring. An embodiment further computes the risk value of the hiring risks associated with the specified job requirement. An embodiment computes possible risk minimization options. An embodiment further presents the forecasts, risk values, and risk minimization options in an interactive manner to enable real-time adjustments to the job requirement in view of the forecasts, risks, and options to arrive at an optimal job requirement. This manner of real-time discovery of risk optimal job requirements is unavailable in the presently available methods. Thus, a substantial advancement of such devices or data processing systems by executing a method of an embodiment is in efficient, real-time determination of hiring difficulties in a job requirement and adjusting the job requirement to enable hiring completion with minimized risks that is possible with the presently available methods.

The illustrative embodiments are described with respect to certain types of skill tuples, standardized skills, skill levels, normalized levels, resume data, requirements data, distances, risk values, thresholds, time frames, time limits, algorithms, risk minimization options, changes caused by change inputs, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

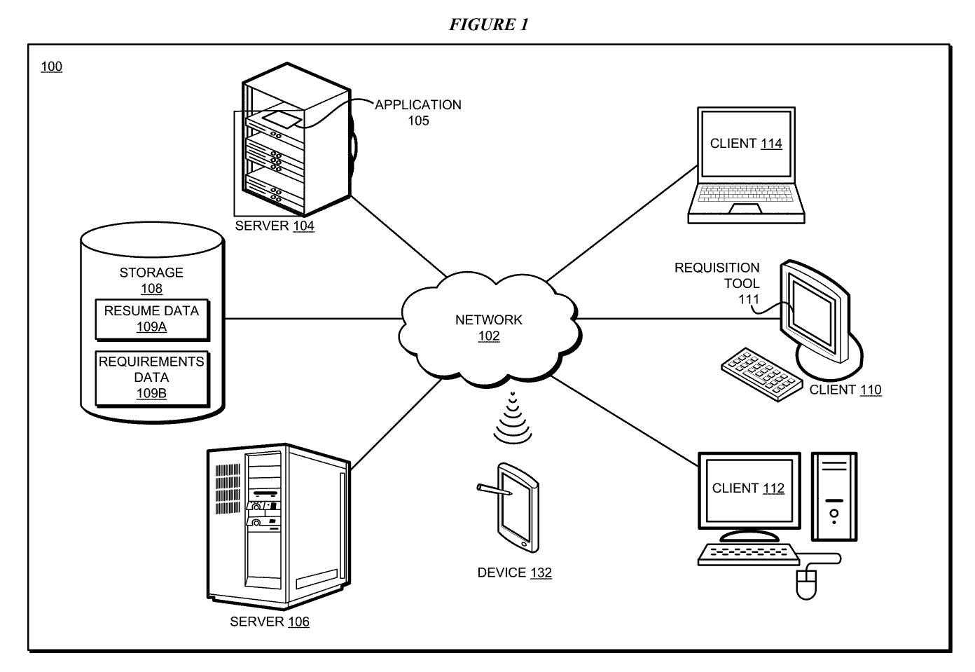

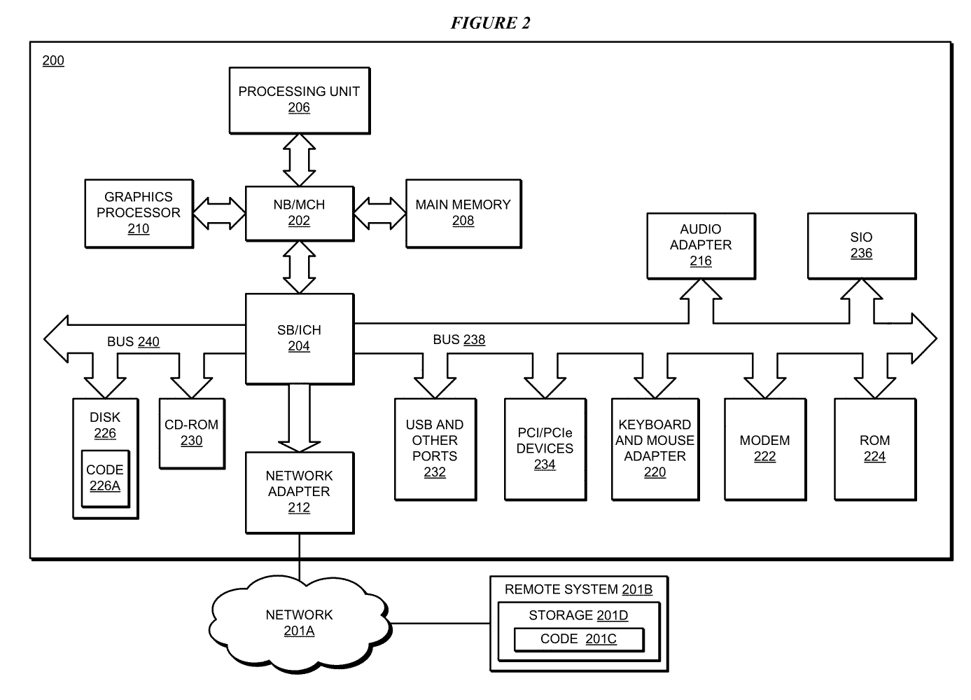

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular Implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Any number of instances of application 105 can execute on server-side, e.g., on nodes in server 104 and/or server 106. Application 105 constructs and uses resume data 109A and requirements data 109B in a manner described herein. Requisition tool 111 is an example tool used to present the forecasts, risk values, and risk minimization options, among other artifacts as described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

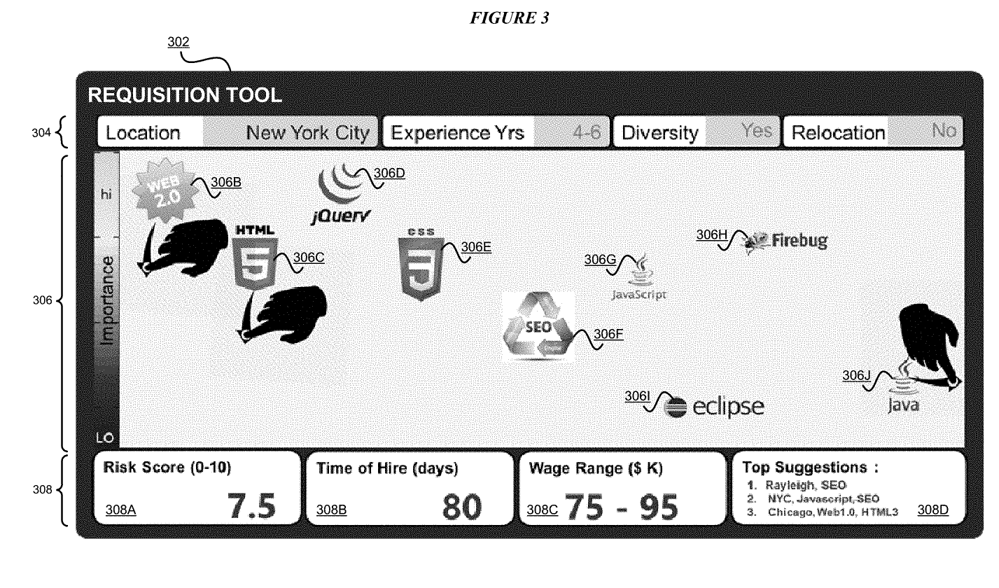

With reference to FIG. 3, this figure depicts an example configuration of a requisition tool in accordance with an illustrative embodiment. Tool 302 is an example of requisition tool 111 in FIG. 1.

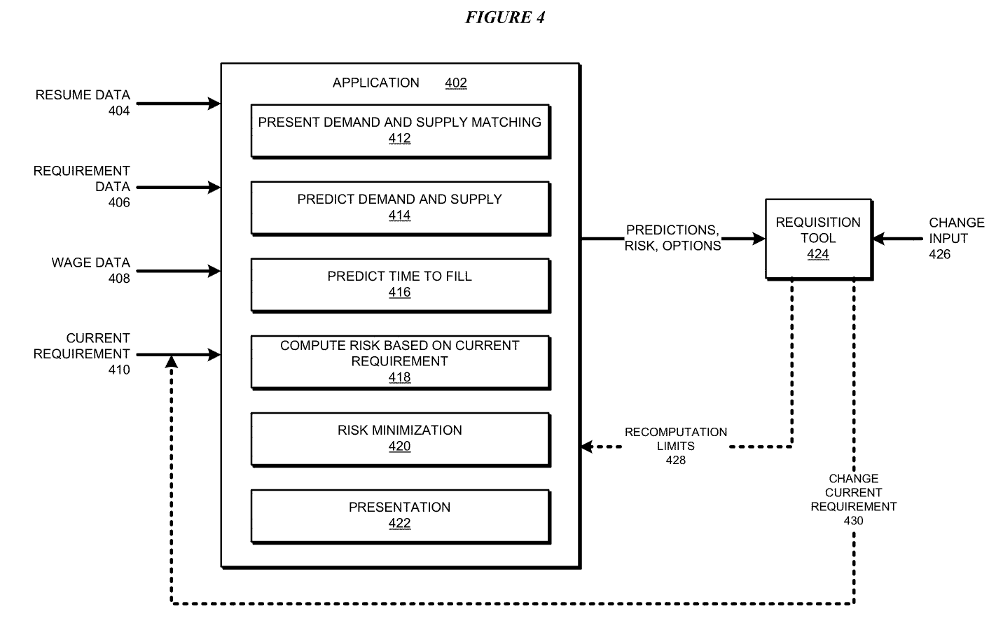

With reference to FIG. 4, this figure depicts a block diagram of an example configuration for real-time discovery of risk optimal job requirements in accordance with an illustrative embodiment. Application 302 is an example of application 105 in FIG. 1. Row 304 depicts an example set of fields that can be populated with one or more values from a job requirement. As described herein, a job requirement can also include one or more locations of the opportunity as shown in one or more “location” fields” in row 304. A job requirement can include an overall level of expertise for all applicable skills—as shown in the “experience Yrs” field of row 304.

Alternatively, or in addition thereto, the job requirement can include different levels of expertise or different levels of importance associated with different skills, as shown in window 306. Window 306 includes importance scale 306A and the placement of the various skills 306B, 306C, 306D, 306E, 306F, 306G, 306H, 306H, and 306J along importance scale 306A is indicative of a level of expertise associated with the skill. A user, such as a hiring manager, can interactively adjust the importance of a skill, so as to create a different job requirement as described herein. For example, the hand icon depicted with skill 306B shows the user dragging skill 306B lower on importance scale 306A, thereby decreasing the importance or expertise level of skill 306B. Similarly, the hand icon depicted with skill 306C shows the user dragging skill 306C lower on importance scale 306A, thereby decreasing the importance or expertise level of skill 306C; and the hand icon depicted with skill 306J shows the user dragging skill 306J out of window 306, thereby removing skill 306J from the different job requirement. new skills can be added and/or an importance or expertise level of a skill can be increased in a similar manner.

Row 308 depicts a set of fields to present the computed risk value of the current job requirement (field 308A), a predicted time to fill the current job requirement (field 308B), wage range that can be expected for filling the job requirement with the specified risk value and time to fill (field 308C), and one or more risk minimization options (field 308D).

With reference to FIG. 4, this figure depicts an example configuration for real-time discovery of risk optimal job requirements in accordance with an illustrative embodiment. Application 402 is an example of application 105 in FIG. 1.

Resume data 404 is an example of resume data 109A in FIG. 1. In one configuration (not shown), application 402 is configured with a component (not shown) to compute resume data 404 from the text of resumes available in a repository (not shown).

Requirements data 406 is an example of Requirements data 109B in FIG. 1. In one configuration (not shown), application 402 is configured with a component (not shown) to compute Requirements data 406 from the text of job requirements available in a repository (not shown).

Wage data 408 is data about wages as described herein, and is available from a data source (not shown). Current requirement 410 is an initial job requirement created by a hiring manager. For example, current requirement 410 may be an over-inclusive job requirement which suffers from the disadvantages described herein.

Component 412 constructs the present supply tuples from resume data 404 and the present demand tuples from requirements data 406 as described herein. Component 412 further performs a matching between the supply tuples and the demand tuples to determine the match values for the various supply tuples.

Component 414 forecasts a gap or glut in the supply tuples of different types. Particularly, given a base tuple, which component 414 forms from current requirements 410, component 414 predicts the supply quantity to meet the demand of current requirement 410 during the predicted time to fill.

Component 416 predicts the time to fill given the base tuple. Component 418 computes a risk value associated with the hiring based on current requirement 410.

Component 420 computes one or more second tuples with corresponding one or more second risk values. Component 420 selects a subset of the computed second tuples and their second risk values as the risk minimization options for current requirement 410.

Component 422 presents the predictions, the risk values, and the risk minimization options on requisition tool 424. Requisition tool 424 is an example of requisition tool 302 in FIG. 3.

A user, such as a hiring manager, provides change input 426 as described herein. Using change input 426, tool 424 supplies time limit 428 for the recomputations as described herein. Using change input 426, tool 424 also supplies changed current requirement 430 as described herein. For example, changed current requirement 430 may be one of the risk minimization options computed by component 420.

Changed current requirement 430 replaces current requirement 410 in the next iteration of the computations. Application 402 continues operating in this iterative manner in real-time until no more change input 426 is received at tool 424. Current requirement 410 prevailing at such time becomes the optimal job requirement as described herein.

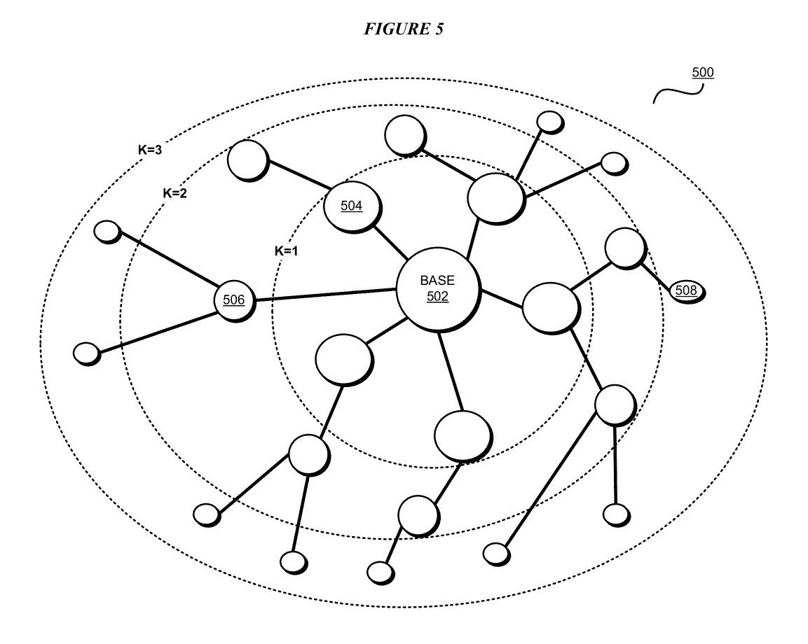

With reference to FIG. 5, this figure depicts an example graphical representation of a process for computing second tuples in accordance with an illustrative embodiment. Graph 500 or some equivalent thereof is used by one embodiment of component 420 in FIG. 4 to compute risk minimization options.

Base node 502 represents a base tuple. K values, e.g., K=1, K=2, K=3, etc. represent the distance of the second tuples from base node 502. For example, node 504 is a second tuple at distance 1 from the base tuple of base node 502 in a manner described herein. Similarly, node 506 is a second tuple at distance 2 from the base tuple of base node 502, and node 508 is a second tuple at distance 3 from the base tuple of base node 502 in a manner described herein.

The selection of nodes 504, 506, and 508 as second tuples may be random or according to a rule suitable for an implementation. For example, a rule may be that some particular skills may never be removed or reduced to construct a second tuple. Another example rule may be that when a certain skill is removed or reduced, another skill must also be reduced (or increased), or removed (or added).

Furthermore, the computation of the second risk value corresponding to a second tuple may be delegated to a separate data processing system. For example, one data processing system executing one instance of component 420 of FIG. 4 may compute the second risk value of node 504 and a different data processing system executing another instance of component 420 of FIG. 4 may compute the second risk value of node 506. Furthermore, different second risk values may be computed using different algorithms. For example, the risk of node 504 may be calculated using a more precise algorithm than the risk of node 506 or 508.

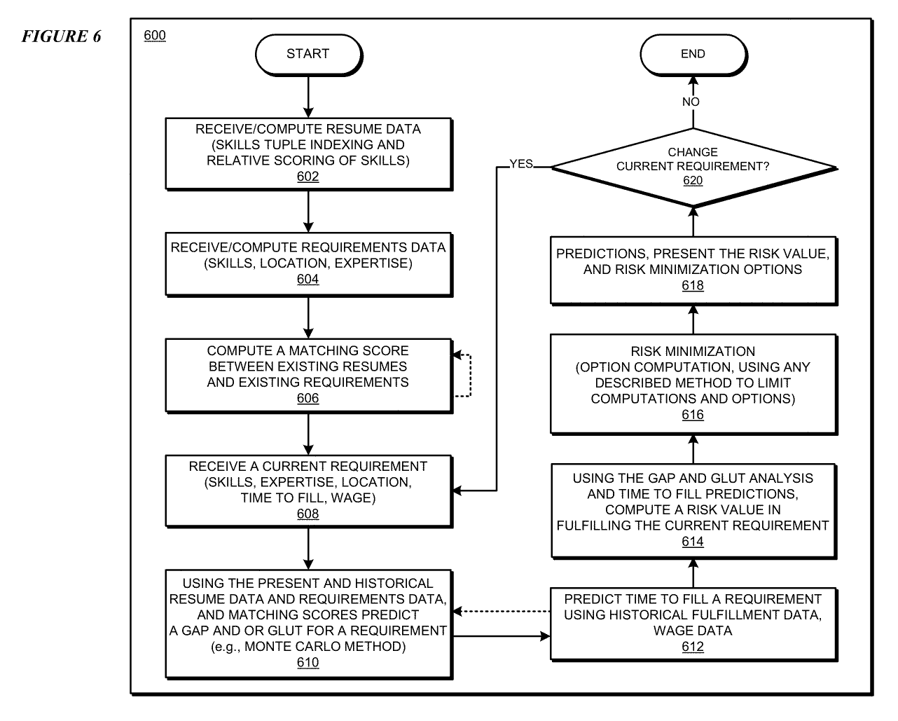

With reference to FIG. 6, this figure depicts a flowchart of an example process for real-time discovery of risk optimal job requirements in accordance with an illustrative embodiment. Process 600 can be implemented in application 402 in FIG. 4.

The application receives or computes resume data (block 602). The application receives or computes requirements data (block 604). The application computes a matching score between existing resumes and existing requirements using the resume data and the requirements data (block 606).

The application receives a current job requirement (block 608). The application uses the present and historical resume data, requirements data, and matching scores to predict a gap or glut for a current job requirement (block 610). The application uses the historical fulfillment data, i.e., the historical completed hiring data as described herein, to predict a time to fill the current job requirement (block 612). If wage is specified in the job requirement, then the application also uses wage data from one or more data sources to compute the time to fill given the offered wage in the current job requirement.

The application, using the gap and glut analysis and time to fill prediction, computes a risk value in fulfilling the current job requirement (block 614). The application performs risk minimization option computation using any of the methods described herein (block 616).

The application outputs the predictions, the risk value, and the risk minimization options on a requisition tool (block 618). The application determines whether an input is received to change the current job requirement (block 620). If an input is received (“Yes” path of block 620), the application returns to block 608 to receive the changes as a changed current job requirement and re-perform the steps thereafter using the changed current job requirement. If an input is not received (“No” path of block 620), the application ends process 600 thereafter.

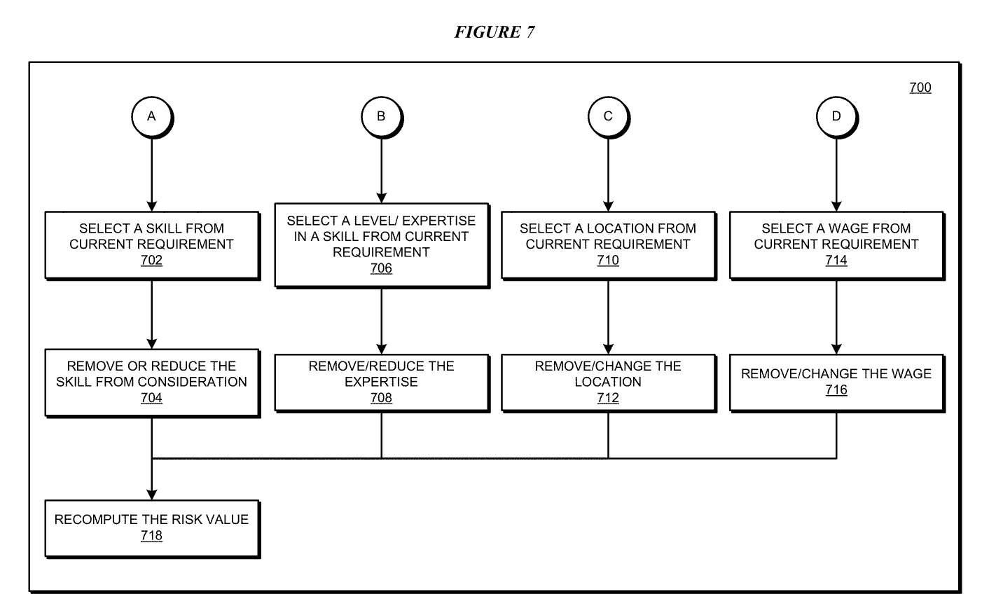

With reference to FIG. 7, this figure depicts a flowchart of an example process for computing risk minimization options in accordance with an illustrative embodiment. Process 700 can be implemented in block 616 of FIG. 6.

The application can perform one or more of the process branches A, B, C, or D to compute a second tuple as described herein. For example, in branch A, the application selects a skill from the current job requirement (block 702). In other words, the application selects a skill from the base tuple formed from the current job requirement. The application removes the skill or reduces the skill's importance to form a second tuple at a certain distance from the base tuple (block 704).

As another example, in branch B, the application selects a level of skill or expertise from the current job requirement (block 706). The application reduces the skill's level or expertise to form a second tuple at a certain distance from the base tuple (block 708).

As another example, in branch C, the application selects a location from the current job requirement (block 710). The application removes or changes the location to form a second tuple at a certain distance from the base tuple (block 712).

As another example, in branch D, the application selects a specified wage from the current job requirement (block 714). The application changes or removes the wage to form a second tuple at a certain distance from the base tuple (block 716).

The application computes a risk value associated with the one or more second tuple formed via one or more iterations through any combination of branches A, B, C, and D (block 718). The computed risk value of the second tuple forms the second risk value as described herein. The application outputs the second tuple and the corresponding second risk value as a risk minimization option at block 618 in FIG. 6 if the second risk value is less than the risk value of the base tuple.

Thus, a computer implemented method, system or apparatus, and computer program product are provided in the illustrative embodiments for real-time discovery of risk optimal job requirements and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
forecasting an amount of time needed to fill a job requirement;
forecasting, by executing a forecasting algorithm using a processor and a memory, a numerosity of resumes matching the job requirement during the amount of time;
computing, using the numerosity and the amount of time, a risk value corresponding to the job requirement, the risk value being indicative of a probability that the job requirement will go unfulfilled in the amount of time;
constructing, from a base tuple corresponding to the job requirement, a second tuple, the second tuple having a distance from the base tuple;
computing, in real-time, using the processor and the memory, a second risk value corresponding to the second tuple; and
presenting, responsive to the second risk value being less than the risk value, data of the second tuple as a risk minimization option for the job requirement.

2. The method of claim 1, further comprising:
forecasting a second amount of time needed to fill a second job requirement corresponding to the second tuple;
forecasting, by executing a second forecasting algorithm, a second numerosity of resumes matching the second tuple during the second amount of time; and
using the second amount of time and the second numerosity in computing the second risk value.

3. The method of claim 2, wherein the executing the second algorithm uses a second processor and a second memory.

4. The method of claim 1, further comprising:
constructing from the base tuple a third tuple, the third tuple having a second distance from the base tuple;
computing, in real-time, using the processor and the memory, a third risk value corresponding to the third tuple; and
omitting from presenting, responsive to the third risk value being higher than the risk value, data of the third tuple as a risk minimization option for the job requirement.

5. The method of claim 1, further comprising:
receiving an input, the input selecting the data of the second tuple as a revised job requirement;
replacing the job requirement with the revised job requirement;
recomputing based on the second tuple, in real-time, the amount of time to form a revised amount of time to fill the revised job requirement;
recomputing based on the second tuple, in real-time, the numerosity to form a revised numerosity of resumes matching the revised job requirement during the revised amount of time;
computing, in real-time, a third tuple and a corresponding third risk value; and
presenting, responsive to the third risk value being less than the second risk value, data of the third tuple as a risk minimization option for the revised job requirement.

6. The method of claim 1, further comprising:
computing a set of supply tuples from a set of resumes; computing a set of demand tuples from a set of job requirements;
constructing the base tuple from the job requirement;
computing a matching score of the base tuple based on a matching score of a demand tuple in the set of demand tuples, wherein the matching score of the demand tuple corresponds to a number of supply tuples that match the demand tuple within a threshold degree of match; and
using, in the forecasting of the amount of time, the matching score of the base tuple.

7. The method of claim 1, further comprising:
determining using wage data corresponding to a set of filled job requirements, a wage range associated with a supply tuple corresponding to a resume that matches a demand tuple of the job requirement; and
increasing the risk value of the job requirement responsive to determining that a wage specified in the job requirement is below the wage range.

8. The method of claim 1, further comprising:
determining a location associated with a supply tuple corresponding to a resume that matches a demand tuple of the job requirement; and
increasing the risk value of the job requirement responsive to determining that a location specified in the job requirement is different from the location associated with the supply tuple.

9. The method of claim 1, wherein the risk value is computed in real-time.

10. The method of claim 1, further comprising:
changing, from a set of skills identified in the base tuple, a subset of skills; and
using, in the constructing, the subset of skills that have changed and a second subset of skills that are unchanged from the base tuple.

11. The method of claim 10, wherein the changing comprises removing the subset of skills.

12. The method of claim 1, further comprising:
changing, from a set of expertise levels identified in the base tuple, a subset of expertise levels; and
using, in the constructing, the subset of expertise levels that have changed and a second subset of expertise levels that are unchanged from the base tuple.

13. The method of claim 12, wherein the changing comprises reducing the subset of skills.

14. The method of claim 1, further comprising:
changing a location identified in the base tuple to a second location; and using, in the constructing, the second location.

15. The method of claim 14, wherein the changing comprises removing the location, making the second location a null value.

16. The method of claim 1, further comprising: changing a wage identified in the base tuple to a second wage; and
using, in the constructing, the second wage.

17. A computer usable program product comprising one or more computer-readable storage devices, and program instructions stored on at least one of the one or more storage devices, the stored program instructions comprising:
program instructions to forecast an amount of time needed to fill a job requirement;
program instructions to forecast, by executing a forecasting algorithm using a processor and a memory, a numerosity of resumes matching the job requirement during the amount of time;
program instructions to compute, using the numerosity and the amount of time, a risk value corresponding to the job requirement, the risk value being indicative of a probability that the job requirement will go unfulfilled in the amount of time;
program instructions to construct, from a base tuple corresponding to the job requirement, a second tuple, the second tuple having a distance from the base tuple;
program instructions to compute, in real-time, using the processor and the memory, a second risk value corresponding to the second tuple; and
program instructions to present, responsive to the second risk value being less than the risk value, data of the second tuple as a risk minimization option for the job requirement.

18. The computer usable program product of claim 17, wherein the computer usable code is stored in a computer readable storage device in a data processing system, and wherein the computer usable code is transferred over a network from a remote data processing system.

19. The computer usable program product of claim 17, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to forecast an amount of time needed to fill a job requirement;
program instructions to forecast, by executing a forecasting algorithm using a processor and a memory, a numerosity of resumes matching the job requirement during the amount of time;
program instructions to compute, using the numerosity and the amount of time, a risk value corresponding to the job requirement, the risk value being indicative of a probability that the job requirement will go unfulfilled in the amount of time;
program instructions to construct, from a base tuple corresponding to the job requirement, a second tuple, the second tuple having a distance from the base tuple;
program instructions to compute, in real-time, using the processor and the memory, a second risk value corresponding to the second tuple; and
program instructions to present, responsive to the second risk value being less than the risk value, data of the second tuple as a risk minimization option for the job requirement.
